(19) United States
(12) Patent Application Publication
(10) Pub. No.: US 2005/0175885 A1
(43) Pub. Date: Aug. 11, 2005

(54) Process and apparatus for energy storage and release

(76) Inventors: Timothy James Imholt, Carrollton, TX (US); David Allara, State College, PA (US); Bruce Gnade, Lewisville, TX (US); James Andrew Roberts, Krum, TX (US)

Correspondence Address: FOLEY AND LARDNER;SUITE 500, 3000 K STREET NW, WASHINGTON, DC, 20007, US

(21) Appl. No.: 10/845,722

(22) Filed: May 14, 2004

Related U.S. Application Data
(63) Continuation of application No. 10/764,092, filed on Jan. 23, 2004.
(60) Provisional application No. 60/442,385, filed on Jan. 24, 2003.

(51) Int. Cl. H01M 4/86; H05B 6/64

(52) U.S. Cl. 429/40; 219/680

(57) ABSTRACT

What is disclosed is a process and apparatus for subjecting carbon nanotubes (100), to EM radiation for certain predetermined amounts of time. The result of said process and apparatus is heat release, light emission and gas evolution, accompanied by intense mechanical motion and carbon nanotube reconstruction.

### CROSS REFERENCE TO RELATED APPLICATION; CLAIM OF PRIORITY

This application is a continuation of U.S. patent application Ser. No. 10/764,092, Imholt, et al., filed Jan. 23, 2004, which claims priority to U.S. Provisional Patent Application No. 60/442,385, filed on Jan. 24, 2003, entitled “Process and Apparatus for Microwave Desorption of Hydrogen and Other Elements from Carbon Nanotubes”, the entire contents of which are incorporated herein by this reference. The Applicant hereby claim the benefits of this earlier pending regular and provisional application under 35 U.S.C. Section 119(e).

### BACKGROUND OF THE INVENTION

Because there are a variety of problems associated with the use of fossil fuels, most notably finite supply, pollution and production of greenhouse gases, hydrogen is viewed as a potential source of energy. Hydrogen burns cleaner and produces more energy per unit mass than any of the fossil fuels. However, there are a variety of problems inherent in the use of hydrogen as a fuel. These problems include extreme volatility, gas expansion, and the lack of safe storage techniques.

There have been a variety of different avenues of research of hydrogen storage systems intended for use in the vehicle market. These methods include physical storage via compression of liquefied gas; chemical storage in a non-reversible hydrogen carrier; reversible metal and chemical hydride batteries; and gas adsorbed onto solids. Regardless of the storage medium two objectives are frequently cited in order for a method of hydrogen storage to be attractive to the automobile industry: (1) 6.5% of the overall weight of the storage system must be hydrogen and (2) 62 kg of hydrogen must fit in a cubic meter. A significant problem that occurs in vehicles utilizing liquid hydrogen under pressure is that liquid hydrogen will evaporate at approximately 1% per day and as much as 30% at the time of re-fueling. Also, a large layer or layers of insulation is required to keep the hydrogen at the 20 Kelvin. Automobiles using these high pressure storage systems also require a large amount of energy input in order to achieve the pressurization of the fuel at the time of re-fueling. There are also a number of safety problems that arise from the high pressure storage of hydrogen.

Hydride cells reduce the danger level of fuel cells which employ liquid hydrogen under pressure. However, these systems suffer from several disadvantages. They require a large amount of energy to desorb the hydrogen from the system. This high desorption energy reduces the overall efficiency of the engine. Fuel cell systems with these hydride cells while safe, may not see commercial use due to these two disadvantages. Hydride systems have seen production in a type of hybrid engine that employs a small fuel cell to power the automobiles engine at times of low energy consumption and an internal combustion engine during times of high power requirements.

Most conventional hydrogen storage techniques have proven to be too bulky for commercialization. Advantageously, carbon nanotubes have been shown to overcome the storage difficulties as they can hold a large amount of hydrogen for their mass in a safe manner. However, one disadvantage of using carbon nanotubes as a storage medium has been the difficulty in removing hydrogen from the carbon nanotubes.

Carbon Nanotubes

Carbon nanotubes fall into two major groups, multi-walled carbon nanotubes (“MWNTs”) and single-walled carbon nanotubes (“SWNTs”). There are a variety of techniques for fabricating SWNTs. Each of these fabrication techniques causes subtle yet important differences in the resulting nanotubes. These differences include changes in length and diameter, and as a result of these, the aspect ratio (defined as length/diameter). The aspect ratio can change by several orders of magnitude and alter the response of the nanotubes to electromagnetic waves. SWNTs are known to form into “ropes” or bundles.

Fabrication and Purification

The first synthesis of carbon nanotubes was a by-product of the arc-discharge method in the fabrication of fullerenes. Their current methods of production are quite varied. These methods include arc-discharge, laser ablation, catalytic hydrocarbon decomposition and carbon monoxide disproportionation to carbon nanotubes plus carbon dioxide (HiPco Process). The MWNTs are made up of 2 to 50 concentric graphitic layers and have diameters in the range of 10 to 100 nanometers (“nm”). The SWNT is much thinner with diameters from 0.5 to 1.8 nm.

Multi-Walled Carbon Nanotubes

The current yield of MWNTs formed in the electric arc-discharge method is near 50% by weight. MWNTs have high chemical stability and very high mechanical strength. The MWNTs, while not having as many applications as the SWNTs, have been available longer and their synthesis is far less expensive than the SWNTs.

When arc discharge is performed with a gap between the carbon electrodes of about 1 mm, cylindrical deposits will form on the surface of the cathode. The diameter of the cathode should be the same as that of the anode. When the diameter of the anode is 8 mm and the electric current is kept at 80 Ampere with He gas pressure of 300 torr, the cathode deposit grows at 2-3 mm per minute. The outer shell of the deposit consists partially of SWNTs with rates up to 30% by weight with the remainder of the material being large clumps of carbon attached to the SWNTs in some way, which must be removed by purification.

The laser ablation method is similar to that first used when C₆₀ was originally discovered. When this method is used for the fabrication of MWNTs, the nanotubes are much shorter than those prepared by the arc discharge method. This method has, therefore, not been utilized for large-scale commercialization of these structures. The advantage of this method is the very high yields, reaching as high as 40% by weight of MWNTs and SWNTs.

The catalytic decomposition of hydrocarbons is a primary fabrication method of MWNTs. The MWNTs produced by this method are much purer than those obtained by the other methods with yields as high as 50% by weight of the deposits being MWNTs. The higher yields in turn require less purification, thus decreasing the cost of fabrication, as the majority of the material removed in the fabrication process is bulk carbon material. Critical aspects of production are length, diameter, and alignment, all of which can be controlled with this method of fabrication.

Single-Walled Carbon Nanotubes

The structure of SWNTs is essentially rolled up graphite forming a very small, thin cylinder with no seam. The length and the diameter of these types of nanotubes are dependent on the type of metallic catalyst employed and the precise methodology used during fabrication. The maximum-recorded lengths have been in the cm length scale with diameters ranging from 0.5 nm to 3 nm. The structure and characteristics of SWNTs are closer to those of fullerenes than MWNTs. SWNTs are a novel one-dimensional material having many unique physical properties. MWNT properties are more closely approximated to bulk graphite. In general, the fabrication of SWNTs is almost the same as with MWNTs with the addition of a metallic catalyst. The catalysts typically used are Fe, Co, Ne, Cu, and Mg. In some experiments the catalysts have been combined in an effort to increase yields.

Electric arc discharge fabrication of SWNTs results in very low yields. Efforts have been made to increase these yields, but with little success. The laser ablation (otherwise known as laser oven) nanotubes produce large yields of nanotubes by utilizing a Co—Ni catalyst. The difficulty in this method is that the amount of amorphous carbon in this apparatus is rather high, making large-scale purification necessary. More recently, it has been shown that SWNTs can be fabricated by hydrocarbon decomposition with an iron catalyst. This fabrication technique allows control of the diameter and length of nanotubes more simply than with previous methods. SWNTs used in one embodiment of the present invention were produced via the HiPco (High Partial Pressure of CO) process. HiPco refers to a process of growing SWNTs using high pressure carbon monoxide in a vapor disproportionation process. In order to be of any practical or commercial use, nanotubes must be produced with high levels of purity in large quantities. The HiPco process has shown some promise of being scaled up for large scale production and can also produce nanotubes that are >90% pure. In this synthesis process, a reaction of Fe(CO)₅ and CO gas at high pressure and high temperature takes place. When the metal catalyst atoms form larger clumps of material, approximately the size of the C₆₀ molecule, they nucleate and form SWNTs. This occurs because a SWNT is a more stable form of carbon than what is in the chamber at this point in the process. Due to this, the carbon will preferentially take on the SWNT form.

Electronic Properties of Single-Walled Nanotubes

The configuration of a carbon nanotubes (hereinafter, assumed to be SWNTs) is fabricated by rolling up a sheet of monolayered graphite. Any configuration can be reached by changing the chiral angle. This angle is defined by the chiral vector R=aX+bY. X and Y are both exactly equal and hold the value (3)^{1/2} D_{c}. D_{c} is the carbon-carbon bond length. If a nanotube is generated by some chiral vector (a,b) it is referred to as nanotube (a,b). This is the convention utilized in the majority of the literature. The fabricated SWNTs will fall into one of three basic forms known as armchair, zigzag or helical. Further, two parameters determine if a nanotube is metallic or semiconducting—the vector (a,b), mentioned above. The type of nanotube can be calculated in the following fashion.

| | | |
|---|---|---|
| Metallic: | 2a + b = 3N | (N is any positive integer) |
| Semiconducting: | 2a + b ≠ 3N | (N is any positive integer) |

By “metallic,” it is meant that there is a zero bandgap in the electronic structure or semi metallic with meVs of bandgap in semiconductor having about 1 meV of bandgap.

Interior Spaces of Carbon Nanotubes

Various mechanisms have been suggested as to how to fill the inner cavity of carbon nanotubes. It has also been suggested that once filled, the properties of carbon nanotubes will undergo great change. The filling of nanotubes by liquids has been achieved experimentally. The efficiency of the filling is related to the liquid surface tension. Studies have revealed a spontaneous capillary effect for different substances. This effect occurs when a material is spontaneously absorbed into the interior of the nanotube, filling the inner void.

Researchers have attempted to place hydrogen inside carbon nanotubes. Much of the hydrogen is stored on the outer surfaces and interstitial areas in the nanotube ropes. This leaves the interior spaces also available for storage of hydrogen. In order to place the hydrogen inside the nanotubes, many different techniques have been attempted, such as high-pressure environments and liquid hydrogen baths. One approach involves channeling hydrogen through the walls of the nanotubes. This channeling and storage can be achieved with kinetic energy levels in the range of 2-20 eV.

Mechanisms of Hydrogen Storage in Carbon Nanotubes

There have been disclosed a number of studies of adsorption of not only hydrogen but other gases on various adsorbent structures. Primary interest has been given to the noble gases near surfaces of carbon nanotube walls. Some of these works are concerned not only with the physical adsorption to surfaces but also with models of gases in pores with hard walls or repulsive interfaces such as those found in carbon nanotubes. The adsorption of hydrogen and nitrogen has been extensively studied at different pressures and temperatures with the ultimate goal of understanding the physical mechanism of adsorption of carbon nanotubes. There has been some level of agreement between numerical simulations for hydrogen adsorption on the surface of carbon nanotubes indicating that the natural tendency of these surfaces is to adsorb the gases rather than absorbing them internal to the capillary spaces. The overall efficiency of adsorption is similar in nature to that of planar graphitic surfaces. What is desired is a means to make use of the pore volume in carbon nanotubes by which its storage capacity could be increased by a factor of ten. By controlling parameters such as nanotube diameters and lengths adsorption capacity can be maximized. These studies of gas adsorption on nanostructures suggest that there is a possibility of adsorbing enough hydrogen on SWNTs for practical commercial application.

The filling of the inner capillary of carbon nanotubes will contribute greatly to their use as fuel cell storage mediums. Presumably, this can be achieved through channeling of the hydrogen atom or molecule into the nanotube. If a beam of hydrogen atoms were incident on the walls of the nanotubes with energy levels of approximately 20 eV, the atoms will rip through the wall and enter the nanotube. The defects in nanotubes on the scale caused by the channeling will self-repair in approximately 1 pico-second.

There is debate as to how well hydrogen can be stored in and on and removed from carbon nanotubes. There are reports that hydrogen may be stored at the rate of 5-10% by weight in SWNT bundles when H₂ molecules are physisorbed to the exterior surfaces and the interstitial areas between the nanotubes in the bundles. Current theories concerning where hydrogen is “stored” in a nanotube matrix is tending toward physisorption on the surface.

For some molecules, certain locations can be immediately ruled out as possible storage locations, assuming that the ropes and bundles will not ‘swell’ in physical dimension. For example, the interstitial channel in the nanotube rope is roughly equal to the kinetic diameter of the H₂ molecule, making it unlikely that much gas could be stored in these locations. However, for H₂, as well as other molecules (N₂, O₂, etc.) the internal diameters of the nanotubes are sufficiently large for storage. The more likely locations of stored gas in SWNT bundles is on the external bundles or in a groove formed at the contact point between adjacent tubes on the outside of the bundles. However, despite the natural tendency of hydrogen to be stored externally on the nanotubes, in theory, it may be placed inside the nanotubes by artificial implantation techniques. One of these methods is referred to as the “flip in” method. If the hydrogen atom is incident on the carbon nanotube with an energy of between 1.52 eV and 20.0 eV, the atom will react with the carbon on the exterior of the nanotubes and still have enough remaining energy to be ‘flipped’ to the interior of the nanotube. If less energetic hydrogen atoms are used, they will be repulsed, more energetic and the nanotube walls may be damaged according to one theory. There are still other theoretical methods of creating hydrogen rich nanotubes. These include the use of high-pressure, pure hydrogen environments and hydrogen environments provided during nanotube fabrication.

Microwaves

Microwave radiation is a term used to describe a range of frequencies in the electromagnetic (“EM”) spectrum typically in the range of 300 MHz to 300 GHz. These frequencies can be described in terms of wavelengths according to:
λ=c/f (1)
where:
λ=wavelength
c=the speed of light
f=frequency of electromagnetic radiation
   This region contains a fairly wide range as compared to other portions of the EM spectrum. Due to the range of wavelengths, the region can be further subdivided into decimeter, centimeter, and millimeter waves.

There are a variety of applications which use electromagnetic waves in the microwave region. These applications include cooking, satellite communications, radar systems and cellular phones. Wavelengths in the microwave region have also found uses in a variety of scientific and commercial applications. An interesting area of application for scientific laboratories is in the acceleration of chemical reactions. The application of microwave radiation of various frequencies and power levels greatly accelerate some chemical reactions that would otherwise take many hours to complete. Efficient removal of hydrogen from nanotubes as well as light emission effects from SWNTs are now shown to be additional applications. If a microwave field is applied to nanotubes, several interesting effects are seen. At certain frequencies such as 2.45 GHz, at certain power levels and at certain distances of the source from the sample, stored hydrogen will be very quickly out-gassed from the sample.

Microwaves, existing at the lower end of the EM spectrum, when considering quantum energies, do not have sufficient energy to cause atoms to go from a ground state to an excited state. They are, in fact, several orders of magnitude away from being able to accomplish this directly. But they are able to couple to the transitions in the hyperfine structure of a dynamical state.

### SUMMARY OF THE INVENTION

Elements such as hydrogen, oxygen, argon and nitrogen, or species, are purged from carbon nanotubes when they are heated. A variety of “brute force” techniques can be used to heat carbon nanotubes, but these methods also heat the vessel which is holding the carbon nanotubes, as well as items located thereabout. These techniques can damage the carbon nanotubes in various ways, in many cases, making them non-reusable. Further, conventionally used desorption techniques are very slow in rendering the adsorbed or absorbed gas for use. As such, these techniques are not useful in fuel cell applications. The present invention has the advantage of, among other things, making fuel such as hydrogen or oxygen, or other gases, such as nitrogen or argon, available for use in a fraction of a second to a few seconds, rather than in minutes. The present invention comprises a process of applying a moderately powered microwave field (1.01×10⁻⁵ eV) to SWNTs that contain an alternative fuel such as hydrogen or oxygen or other gas such as nitrogen or argon.

The carbon nanotubes are heated as a result of their interaction with the microwaves. The technology used in generating microwaves is mature, such that microwave generators can be made portable with little difficulty. With adequate shielding, portable microwave sources can be made safe for use in vehicles or power generator applications. If a microwave transparent container is used, advantageously, only the carbon nanotubes are heated. Conventionally available microwave transparent containers can be used in the process and apparatus of the present invention. Microwaves, when properly applied to the carbon nanotubes, cause an absorbed or adsorbed gas, such as hydrogen or oxygen, or some other gaseous material, to escape the carbon nanotubes. The released gas can then be used for energy production. The carbon nanotubes useful for this process include SWNTs and multi-wall types. However, the use of carbon nanotubes with smaller aspect ratios is preferable as the hydrogen tends to bond better with highly damaged nanotubes. Undamaged carbon nanotubes also can be used advantageously in the present invention. Moreover, low wattage microwaves, i.e. less than 100 W, can also be used to effectively heat nanotubes, thereby providing a safe level of power input and little to no degradative effect to the tube itself.

### FIGURES OF THE INVENTION

FIG. 1(a) illustrates SWNTs in an ultra high vacuum tube suspended above the microwave source wherein the tube is shown containing SWNTs under vacuum with room lights on and FIG. 1(b) illustrates SWNTs under vacuum during microwave irradiation (2.45 GHz, 700 W) with the room lights off;

FIGS. 2(a) and 2(b) illustrate the spectrum of light from raw and purified SWNTs when subjected to microwave irradiation;

FIG. 3 is a plot of the spectra of light from both purified and unpurified HiPco Nanotubes as a microwave field is applied;

FIG. 4(a) is a schematic diagram of a two cavity klystron for generating microwaves;

FIG. 4(b) is a schematic diagram of the reflex klyston for generating microwaves;

FIG. 5(a) is the absorption spectrum of bucky paper in the range of 7 to 12 GHz;

FIG. 5(b) is an absorption spectrum of a 5 mg sample of purified SWNTs in the range of 7-12 GHz;

FIG. 5(c) is an absorption spectrum of a 5 mg sample of purified SWNTs in the range of 7-12 GHz of FIG. 5(b), but with an expanded range in the y-axis;

FIG. 6 shows the results of desorption experiments from samples implanted with hydrogen and samples not implanted with hydrogen;

FIG. 7 illustrates the TEM image of the fused carbon nanotubes after microwave irradiation;

FIG. 8 illustrates TEM image showing looped carbon nanotubes after microwave irradiation; and

FIG. 9 is an RGA plot of outgassed materials from carbon nanotubes during microwave application.

### DESCRIPTION OF THE INVENTION

The process and apparatus of the present invention comprises subjecting carbon nanotubes containing a species, or elements such as hydrogen, oxygen, nitrogen and argon in air, in an inert gas chamber, in vacuum or under ultrahigh vacuum (“UHV”), to microwave radiation for certain predetermined amounts of time. The result of said process is heat release, light emission and gas evolution, accompanied by intense mechanical motion and carbon nanotube reconstruction; reconstruction only occurs if the microwave power is sufficiently high to result in heating of the nanotubes to greater than 1500° C. The apparatus of the present invention is any device that implements the described process.

The present invention is improved over conventional methods with respect to, among other things, its efficiency and its safety characteristics. Further, the process and apparatus has the advantage of removing a gas, particularly hydrogen, much more quickly than any previous methods. Hydrogen can be removed from the carbon nanotubes on the order of seconds or fractions of a second, rather than minutes as is the case with conventional methods. In addition to removing hydrogen, the process of the present invention removes other gases that may be used as fuel sources from carbon nanotubes, such as oxygen. In one embodiment of the present invention, the amount of hydrogen removed from the carbon nanotubes is shown to be approximately 100 times that of any other residual gas. Due to such rapid outgassing, the process of the present invention is particularly adaptable for use in fuel cells for hydrogen-powered automobiles. High strength carbon nanotubes make extremely safe storage vessels for hydrogen for any use.

SWNTs used in one embodiment of the present invention were produced via the HiPco (High Partial Pressure of CO) process. HiPco refers to a process of growing SWNTs using high pressure carbon monoxide in a vapor disproportionation process. In order to be of any practical or commercial use, nanotubes must be produced with high levels of purity in large quantities. The HiPco process has shown some promise of being scaled up for large scale production and can also produce nanotubes that are >90% pure. In this synthesis process, a reaction of Fe(CO)₅ and CO gas at high pressure and high temperature takes place. When the metal catalyst atoms form larger clumps of material, approximately the size of the C₆₀ molecule, they nucleate and form SWNTs. This occurs because a SWNT is a more stable form of carbon than what is in the chamber at this point in the process. Due to this, the carbon will preferentially take on the SWNT form. The average diameter of HiPco nanotubes is 1.1 nm and their lengths can be microns long. These HiPco SWNTs display strong microwave absorption characteristics, e.g., 1.01×10⁻⁵ eV microwave field, with subsequent light emission, intense heat release, out-gassing, mechanical extension and nanotube reconstruction. SWNTs produced via other processes can also be used in the process and apparatus of the present invention.

In air and under application of the microwave field, SWNTs ignite and burn. The regions of the SWNTs that undergo this process show a permanent color change from black to orange. These orange regions fluoresce under normal room light. A TEM image of these orange regions shows a change to amorphous carbon structures that are 50-500 nm in diameter with no discernable tube structure. The purified nanotubes, when in the presence of the microwave field in air, only display random scintillation of white light.

A novel reaction occurs when either purified or raw SWNTs are exposed to microwaves under conditions of vacuum of approximately between 10⁻⁴ torr and 10⁻⁸ torr pursuant to one embodiment of the present invention. Depending on the embodiment, the microwave frequency can be between 0.1 GHz and 100 GHz, including in one embodiment about 2.45 GHz, and the microwave power between 0.1 Watt and 1,500 Watts or where the microwave field incident on the carbon nanotubes is about 1.01×10⁻⁵ eV. Carbon nanotubes in the vacuum system caused higher levels of vacuum (lower pressures) to be reached than normally observed, possibly due to molecular gas adsorption by the carbon nanotubes. Both the raw and purified carbon nanotubes, when placed under vacuum in the presence of the microwave field, emit white light. The process is repeatable with no observable degradation of the light intensity over approximately 20 seconds of microwave irradiation. After minutes of constant exposure, there is a diminution of light, though the carbon nanotubes are still light-emitting. If lower wattage microwaves are used, for example less than 100 Watts, the nanotubes can become sufficiently hot to outgas adsorbed or absorbed gases, however tube reconstruction is less, if at all. FIG. 9 is a plot 900 of the residual gas analysis (“RGA”) of outgassed atomic masses from pure HiPco nanotubes during microwave field application. The spike at located at atomic mass unit 2 represents hydrogen in molecular form. This chart is in a log scale and the quantity of hydrogen removed is approximately 100 times more than any other atomic mass. Short exposure pulses of approximately 3 to 5 seconds can be repeated with no obvious degradation over the 35 pulses attempted.

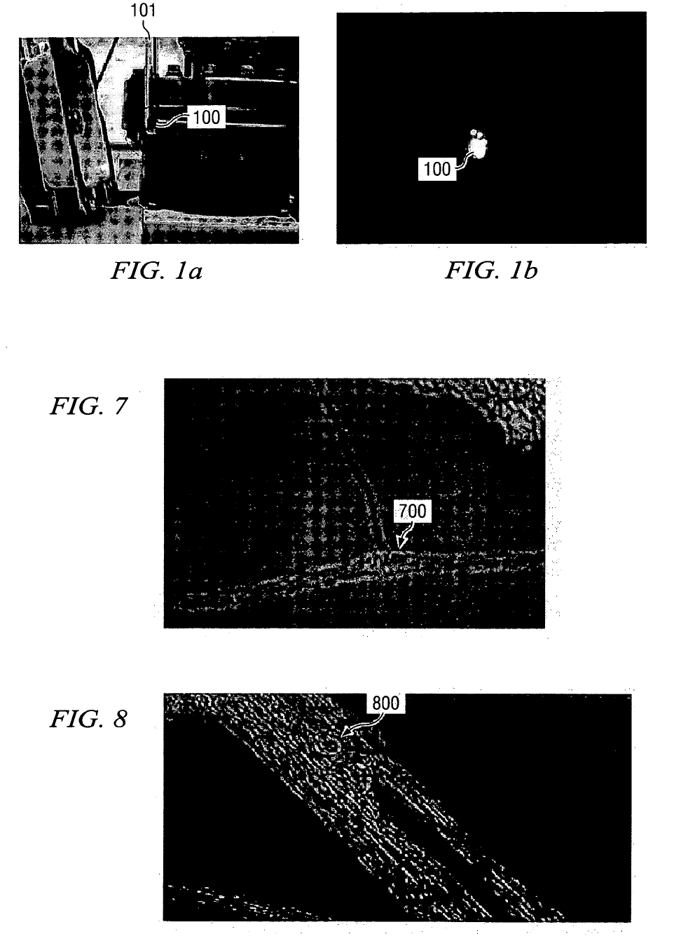

FIG. 1(a) illustrates SWNTs 100 in an ultra high vacuum tube 101 suspended above the microwave source wherein the tube is shown containing SWNTs under vacuum with room lights on. FIG. 1(a) shows a sample of HiPco nanotubes as a microwave field is applied. FIG. 1(b) illustrates SWNTs 100 in an ultra high vacuum tube 101 suspended above the microwave source wherein the tube is shown containing SWNTs under vacuum during microwave irradiation at a frequency of 2.45 GHz and 700 Watts of power with the room lights off.

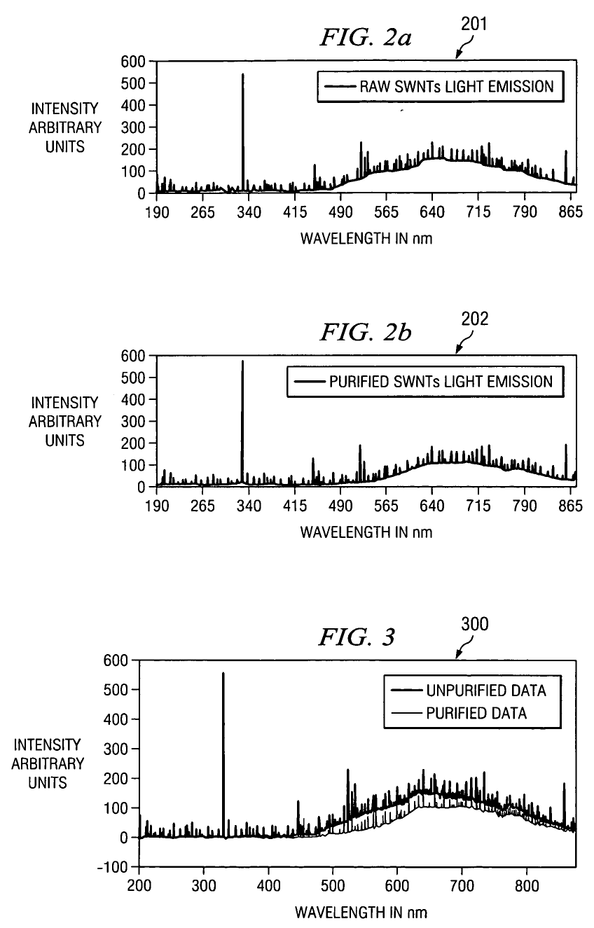

Light emissions from carbon nanostructures have been previously observed in C₆₀. The light in the current experiment is very broadband with peaks superimposed on the broadband emission spectrum. These emissions extend from the ultraviolet (“UV”) range, through visible and into the infrared (“IR”) regions of the electromagnetic spectrum. As seen in plots 200 and 201 of FIG. 2, the majority of the broadband emissions are in the visible and near infrared (“NIR”) regions and the UV components consist mainly of spikes that correspond to carbon, iron (the catalyst in HiPco synthesis), carbon monoxide (the carbon source in HiPco synthesis) and hydrogen. Some of these species may be pyrozylates that are formed through the thermolysis of adsorbed organics such as pump oil which is present, in small quantities, in UHV.

The light emission under UHV conditions is accompanied by outgassing in both the crude and purified carbon nanotubes. The expelled gas is what was previously adsorbed by the carbon nanotubes and consists primarily of hydrogen, as observed using a residual gas analyzer (“RGA”). The described embodiment of the present invention shows microwave fields to be an efficient method for extracting hydrogen from carbon nanotubes. The emission of light from the carbon nanotubes continues after the hydrogen is desorbed.

In addition to the light emission and outgassing, the microwave irradiation of the samples in the described embodiment of the present invention is accompanied by a very rapid temperature increase in the samples. In one embodiment, the temperature reached as high as 2000° C., as measured by a pyrometer, when using 2.45 GHz, 700 W magnetron, which is to be expected with this type of broadband emission.

The heat release, light emission and gas evolution were further accompanied by the carbon nanotube samples undergoing intense mechanical motion. When irradiated with the microwaves as described herein, the initial fluffy material spreads to about twice its original volume, and when the microwave field is turned off, the material contracts back to its near-original size. This occurs in a repeatable manner upon the short exposure cycles even after the majority of the outgassing has occurred. This implies a wide spectrum of phonons being created. The build up of the phonon spectrum in this case is consistent with the visually recorded delay of approximately 1 second for light emission to occur. This may induce electron plasma, which can emit frequencies up to the soft x-ray region, fitting with previous simple models. Repeated exposures to the microwave radiation causes a decrease in the observed mechanical motion, most likely a result of crosslinking or welding of the tubes.

FIG. 3 is a plot 300 of the spectra of light from both purified and unpurified HiPco nanotubes as microwave field is applied. The wavelength is in nanometers and the intensity is in arbitrary units. It should be noticed that most of the peaks are in the same locations on both samples, merely showing different intensities.

One embodiment of the present invention utilizes a microwave source comprising a 700 watt magnetron at 2.45 GHz located proximate to the SWNTs, such that microwave radiation is incident upon the SWNT. Other microwave sources at different power and frequency settings can also be utilized. SWNTs were tested in both the purified and raw conditions. It is often necessary to generate a microwave signal. The generation of low frequency EM signals is usually achieved via the transfer of electrical energy from a steady electric field into an alternating field. In this situation, a signal with the desired frequency is always present. This is typically due to thermal noise. The desired frequency is then selectively amplified to the desired power level by feedback with the phase relation that is appropriate to the application. This technique works reasonably well for frequencies up to approximately 1 GHz.

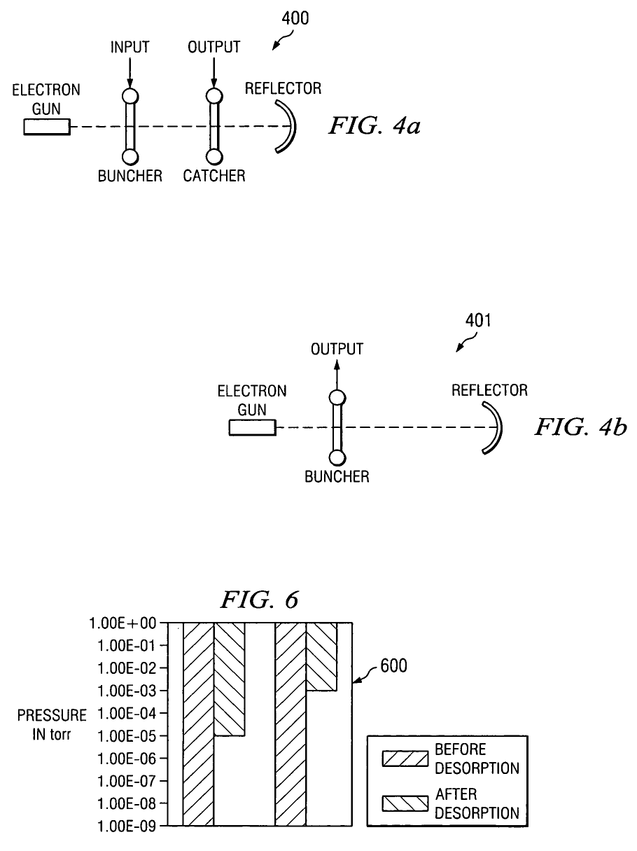

At frequencies of 1 GHz to 10 GHz a different technique is necessary. At these higher frequencies the finite transit times of electrons will have a degrading effect on such things as the oscillator circuit, rendering signal sources very poor without a change of the generation technique. As seen in FIG. 4(a), a specially designed dual cavity klystron 400 with planar triodes is typically employed for signal sources in these ranges. The electron transit time has no effect on these devices due to their geometry. These devices consist of small distances between the triodes and a high accelerating voltage. These triodes are used in conjunction with a tunable dual-resonant cavity. These devices can typically be retuned to a significant portion of the 1 to 10 GHz portion of the microwave spectrum, and the maximum power output from such a device is in the range of 10 Watts.

As seen therein, these dual cavity klystrons consist of two resonant cavities in tandem through which passes an electron beam. A radio frequency (“RF”) field, in the first of the two cavities, will bunch the electrons into groups. These groups then pass into the second cavity and induce an RF field. In other words, the first of the two cavities slightly accelerates some electrons, while others are slowed down. The acceleration and deceleration is determined by which portion of the RF cycle the electrons are in. After several millimeters of transit, the faster electrons will catch the slower ones and the maximum allowable “bunching” will occur. It is at exactly this position that the second of the two resonant cavities is situated. Further along the beam line the accelerated electrons have passed the slower ones and the electrons are again debunched.

If in some portion of the RF cycle energy from the second resonant cavity is fed back to the first resonator in the correct phase, the klystron will become an oscillator. The frequency of oscillation is determined by the resonant frequencies of the cavities (which can be adjusted by changing their physical size). The accelerator voltage may cause a small change in the oscillation frequency.

Where the dual cavity klystron leaves off in frequency, the reflex klystron will take over. A reflex klystron, while capable of emitting higher frequencies, is typically not capable of emitting signals with power levels higher than 1 Watt. This power level, while not useful for most commercial applications, is highly useful in the spectroscopy laboratory, provided the signal is very “clean”. These clean signals are signals with very little drift in center frequency or statistical noise. A reflex klystron offers this type of signal and for this reason, historically, have been the signal source of choice for microwave spectroscopists. As seen in FIG. 4(b), reflex klystron 401 is simplified over the dual cavity version by removal of one of the two cavities. Due to this simplification, it is necessary to add a reflector electrode that is negatively charged. This electrode will reflect the electron beam, just as a mirror reflects visible light. After the beam is reflected it will re-enter the cavity delivering more energy than originally received by the cavity, provided that the reflector to cavity distance is properly tuned and the “repeller” voltage is properly set.

Backward wave oscillators (“BWO”) are another good microwave signal source. In a BWO, the electron beam is compressed with the application of a static magnetic field along the longitudinal axis. These sources are very useful as sweep signal generators due to their ability to be tuned over a fairly wide range of frequencies. This sweeping is not done by mechanical means but rather by varying the electron beam voltage.

For some applications, a much higher power level is required from a microwave source. These applications typically employ a magnetron. In a magnetron source, a static magnetic field is applied perpendicularly to the electron beam. This is to force the electrons into a nearly circular path. This will extend the amount of interaction time and allow a much higher power level to be achieved.

In an effort to remove the need for high beam voltages, new semiconductor devices for microwave measurements have been utilized. Strip line techniques are employed to reduce the physical size of the circuits. These sources are quite versatile, offering excellent frequency stability, on the order of one part in 10⁹, over a wide range of frequencies. These sources are typically very low power, on the order of 100 mW.

The most basic way of detecting any kind of microwave signal is by demodulating the signal, and using a semiconducting diode. These diodes are very mature technology and relatively immune to ‘false’ readings, if used properly. While these devices are relatively error free, on occasion more sensitive detection methods are needed. Increased levels of sensitivity are found in superheterodyne receivers. The signal frequency detected (f) is combined with the frequency of a local oscillator (f_{LO}), and this combination yields an intermediate frequency (IF):
f_{IF}=|f−f_{LO}| (5)
with:
f_{IF}=Intermediate frequency
f=Frequency detected
f_{LO}=Frequency of the local oscillator

The local oscillator frequency must cause the IF to equal the frequency of an IF filter. The filter device allows the signal to be amplified over only a small bandwidth by amplifiers. By using this principle, the frequency of the detected signal is transformed to a lower frequency (between 10 MHz and 300 MHz typically). It is in this lower range that amplifiers produce far less noise. This type of receiver tends to have a much improved signal-to-noise ratio, making it superior to diodes by a factor as large as 10⁵.

To improve detection even further, twin channel superheterodyne receivers are employed. The second channel can be employed to lock the signal frequency by an automatic frequency control unit. This allows for signal sources which do not ‘drift’. Many newer systems will frequently use a network analyzer. In these systems a swept, or stepped frequency source, is locked into a superheterodyne receiver. Vector network analyzers use a dual channel receiver to measure ratios of amplitudes and the differences in phase for the two signals fed in. It is, therefore, capable of determining the real and imaginary parts of an unknown 2 port device. These analyzers typically come packaged with a computer to allow automated measurements, suitable processing of signals such as signal averaging and filtering of background noise. These types of computer controlled devices are intended to reduce errors. The system will attempt to remove what it determines to be systematic errors and display what it thinks is the correct measurement, based on a statistical analysis algorithm, which in many cases tends to remove important details.

In frequency ranges lower than the microwave region, for instance the 60 Hz signal typical of household wiring, lines can be treated as connections with ohmic resistance between elements. In the microwave range other phenomenon must be given consideration. Reactive impedances become important and their importance increases dramatically with frequency. The reactive impedance of a transmission line will be highly dependent on its geometry, shape, and size, thereby making these three things non-trivial in nature. Two wire lines do not work very well for these microwave applications, as the signal in one wire can and may have adverse affects on the other wire due to overlapping EMF fields. The attenuation between two wires will decrease with the distance between them. This makes wire placement and isolation in any piece of microwave equipment an important decision. Waveguides are, therefore, a more favorable technique for transporting a signal from one place to another.

Waveguides are basically hollow pipes and are available in many different geometries. Most common are the rectangular and circular waveguides. There are two types of field configurations inside waveguides. The first has the electric field component in the direction of the wave propagation (TM-modes) and the second has the magnetic field in the direction of wave propagation (TE-modes). For certain configurations, which are dependent on the frequency range used, various physical sizes of waveguides are necessary. This change in size is due to the changes in wavelength associated with the shift in the frequency being examined. Waveguides also do not suffer from the sometimes an enormous amount of signal degradation and loss that can occur in wires making them a far superior method of signal transmission.

Microwaves and Nanotubes

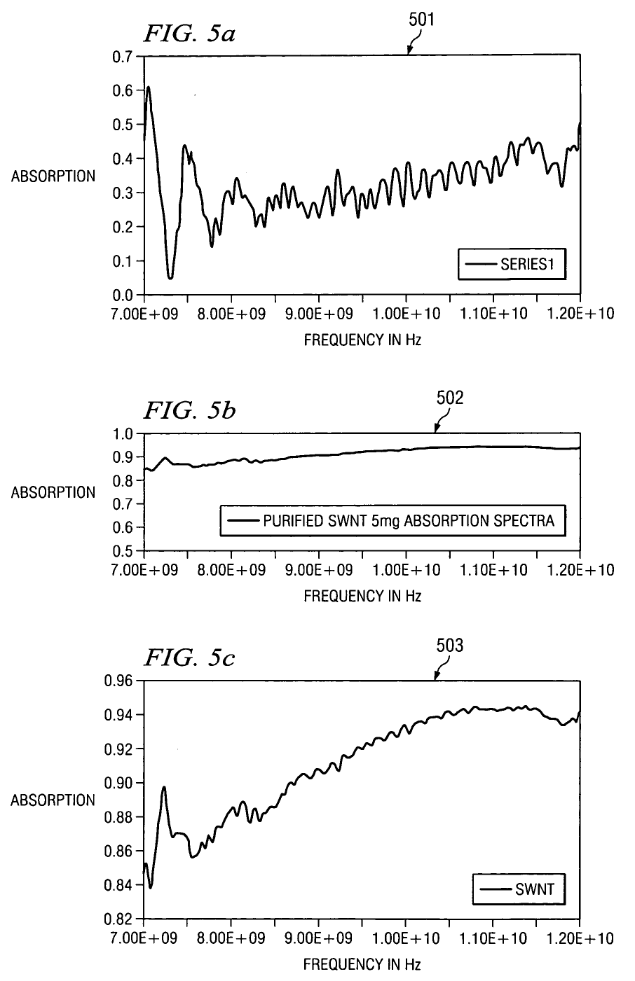

Buckypaper is a thin membrane of purified SWNTs. There is generally no alignment of the tubes in buckypaper and the thickness of the membrane depends on the sample preparation protocol, but it is generally 1-100 microns thick. In FIG. 5(a), absorption spectra of buckypaper over the range of 7 to 12 GHz can be seen. This spectrum was taken with a sweep source and consists of 25 sweeps across the entire range. The results shown are the average of these sweeps to remove experimental error sources. The signals recorded are the transmitted and reflected power levels, which were then added together, and subtracted from the reference voltage. The original reference voltage was then divided into this voltage in order to obtain the “percent” of the microwave signal absorbed by the bucky paper. Carbon nanotubes are known, according to the published work of the inventors, to be efficient microwave absorbers. Normally, long chain molecules absorb over a wide range of frequencies. A group of nanotubes, such as that found in buckypaper, is essentially a large group of very long-chain molecules. These molecules will have different length distributions and the microwaves and nanotubes interact in different ways based on the distribution of lengths. In FIGS. 5(b) and 5(c), an absorption spectrum in the range of 7 to 12 GHz of 5 mg of purified SWNTs can be seen. This shows a larger absorption, which is to be expected, with the increased number of long chain molecules in the sample. These broad-extended, range interactions are not only unusual but, appear to be very useful.

A Mechanism for Interaction

Not intending to be bound by any choice suggestion of mechanism, the interaction of the nanotubes with microwaves is complex, with possibly several mechanisms at work, however, one known interaction could be found from previous long chain molecule research. The valence electrons in long chain, or any nonlinear molecules, do not move in a cylindrically symmetric field. For this reason, no component of their orbital angular momentum can be found to be constant. The electron orbital momentum must be considered as a portion of the rotational momentum of the entire molecule (if it is assumed that the interaction is for only one molecule at a time). The interaction of the electron spin (L) and orbit (S) of the type AL S is only possible when there is a slight uncoupling of L from the rotation of the molecule. Where A: is the largest rotational constant of an asymmetric rotor. L: Electronic angular momentum of an entire atom or molecule, S: Electron Spin Angular Momentum. Another mechanism might involve a microwave interaction with iron nanoparticles that occupy the end of the nanotubes. Upon irradiation with microwaves, the iron nanoparticles efficiently absorbs the microwave and transmits the energy to the nanotube to which it is coupled. A third mechanism could involve an excitation of nanotube electrons from one or more of the tube types (i.e., the semi metallic tubes) into an electron plasma that coats the tube surface. This would account for the light emission and the apparent material expansion during the irradiation cycles.

High Power Interaction

For the spectra 501, 502 and 503 shown in FIGS. 5(a), 5(b) and 5(c) respectively, the microwave sources are very low power sources, which is typical when performing spectroscopic measurements. In order to be of commercial interest in many cases, nanotubes must be able to interact efficiently with high power microwave signals. In the embodiment of the present invention, operating at 2.45 GHz with 750 Wats of power can be employed. When the microwave field emitted from the source described above irradiated SWNTs in their raw, unpurified state in air they ignited and burned within three seconds and powder X-ray diffraction indicated the presence of hematite as an orange residue.

The ignition of the raw nanotube sample was due to a combination of factors. The presence of large amounts of carbonaceous materials, a typical impurity, on the nanotube ropes appears to retard the radiation of heat caused by the microwave absorption. The other factor is that the microwave field will cause the nanotubes to outgas hydrogen. When the hydrogen interacts with several hundred to several thousand degrees centigrade temperatures that the sample appear to reach within the first three to five seconds, an “ignition” in air is to be expected.

When the purified and raw nanotubes are placed in UHV conditions (1×10⁻⁹ torr) another novel phenomenon is seen. Having the nanotubes in the vacuum system allows for a lower level of vacuum to be reached than possible when the nanotubes are not present. The nanotube ropes will adsorb a large amount of hydrogen, which is typically what prevents a UHV system from achieving lower pressure levels, and in this case allowed an order of magnitude drop in pressure in the system with nanotubes compared with the same system without a nanotube sample in place.

Raw and purified nanotubes in UHV under the application of the same microwave field discussed above both emit bright white light. The spectrum of this white light is broadband. Many of the ‘spikes’ on the spectrum that appear at first glance to be signal to noise problems. There are in fact identical in the purified and raw nanotube spectra. It is suggested that these peaks are atomic emission lines belonging to either H, C, CO, or Fe, which constitutes every element present in the sample. SWNT emissions extend slightly further into the UV than those from a sample of purified nanotubes with similar mass. A Geiger counter was placed near the apparatus to test for any high energy emissions beyond UV. Radiation levels slightly higher than the normal background were observed from purified SWNTs where average diameters near 1 nm. This radiation may indicate emissions in the soft x-ray region. The temperatures of both physical and raw SWNTs of the system were observed using a pyrometer that measures blackbody radiation at 2 μm. These observed temperatures were in the range of 2000° C.

In a hydrogen free system, there are several mechanisms that account for the emission of optical, ultraviolet and soft X-rays. SWNTs are mechanically extremely supple, with a wide range of motions possible without destroying the integrity of the nanotubes. Under exposure to a microwave source the nanotubes are found to undergo severe mechanical motion, co-temporal with thermal heating. This implies that a broad spectrum of phonons is being created in the sample and possibly an electron plasma. This is due to the nanotubes having high Q and the presence of defects and contorted geometry. The build-up of the phonon spectrum, since its origin is the dynamical motion of nanotubes, will take seconds. This time scale corresponds to the delay seen before visible radiation occurs.

At some point, the phonon frequency will match the absorption frequency of the outer electrons in the nanotube structure, and they will be ionized, although not intending to be bound by any particular mechanism. This process forms an electron plasma which exchanges energy with the phonon sea. Once the electron plasma reaches the plasma edge, it will radiate in the optical, UV and soft X-ray regions, absorbing and reradiating most of the incident energy in a steady state equilibrium. The entire sample seems to radiate as a single object, due to electron coupling among the nanotubes, which form a “giant dipole resonator.” This system can both absorb and emit electromagnetic energy very efficiently.

SWNTs that have a diameter of one nanometer make them quantum waveguides that delocalize electrons in their interior, adding to the effect by increasing the effective collision cross section. A single nanotube, which is immersed in such a dense spectrum of phonon states, can be considered as a single extended quasi-particle. To a first approximation, it can be thought of as a physical realization of a one-dimensional quantum string. The coupling among nanotubes is so strong, due to phonon and electron exchange, that the material has collective dynamics. Visual reactions to the application of the microwaves to the HiPco SWNTs took place approximately 1 second after application of the microwave field. Laser-oven-generated SWNTs were also utilized. The reactions from this type of SWNT were not easily observable, due, perhaps, to the increased average diameters in these types of SWNTs vs. the HiPco SWNTs or differing amounts of iron remaining in the sample.

Mechanisms of Hydrogen Storage in Carbon Nanotubes

Another aspect of the present invention comprises a process and apparatus for filling of the inner capillary of nanotubes with hydrogen. As noted, if a beam of hydrogen atoms were incident on the walls of the nanotubes with energy levels of approximately 20 eV they will rip through the wall and enter the nanotube. The defects caused in nanotubes on the scale of which would be caused by the channeling will self-repair in approximately 1 pico-second. An accelerator was used to implement the ion beam line process. The energy of an accelerated beam of hydrogen. To implement the channeling process, a 4 mg sample was run in the ion beam line with the incident energy of hydrogen impact the carbon nanotubes of 5 keV. The hydrogen slows down as it passes through more and more nanotubes until it is finally captured the implantation. The particle rate was approximately 1 particle every 10⁻⁹ seconds which is slow enough to allow the self-repairing of the nanotubes. The sample was placed in the apparatus in such a way to measure not only the total charge incident on the sample but also what charge channeled through. This allowed the total number of trapped particles to be determined to be approximately 10¹⁷ hydrogen atoms.

Once these samples were prepared, desorption of two almost identical nanotube samples was conducted. A first sample consisted of 4 mg of SWNTs which had not been implanted with hydrogen via the beam line implantation method, but were bathed in an environment of approximately 100 torr of hydrogen for 1 hour. A second sample was also bathed in an environment of 100 torr of hydrogen for 1 hour and then implanted with approximately 10¹⁷ hydrogen atoms. As seen in FIG. 6, the results 600 of the subsequent desorption experiment show a large increase in the amount of stored hydrogen. For the first sample it was found that the levels of hydrogen in the vacuum system rose from about 10⁻⁹ torr to about 10⁻⁵ torr. For the second sample in the same vacuum system, RGA analysis showed a level of about 10⁻⁹ torr of hydrogen previous to desorption and complete saturation of the instrumentation on the hydrogen channel following desorption. As the RGA does not saturate until 10⁻³ torr, this indicates a large increase in the amount of hydrogen removed from the sample indicating that the implantation was possible. FIG. 9 is an RGA plot 900 of outgassed materials from carbon nanotubes during microwave application.

Carbon Nanotubes after Irradiation

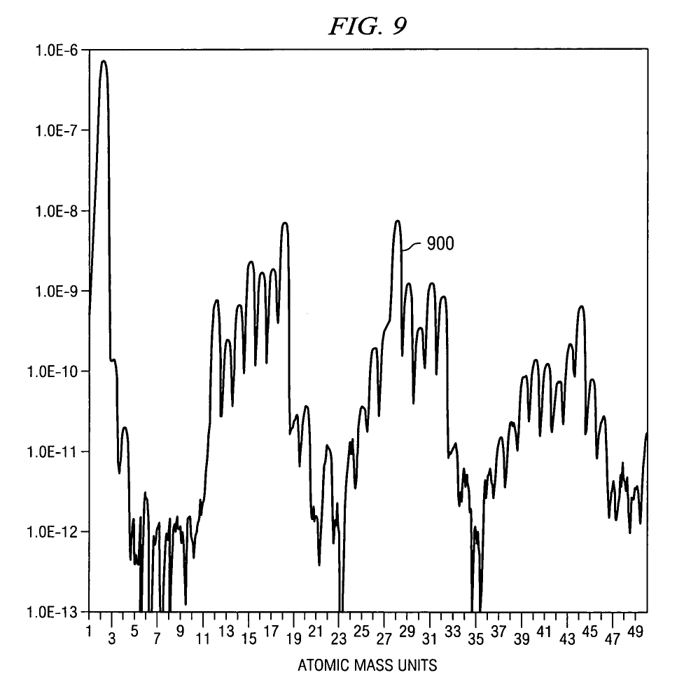

Another aspect of the present invention is as an effective means of welding nanotubes or nanotube-based ropes in their pure states or after dispersion in blends or composites, thereby altering the mechanical properties of the final materials. TEM imaging of the carbon nanotubes after microwave irradiation in UHV showed that many of the nanotubes fused or welded into neighboring tubes to form junctions. The well-defined junction formations 700 can be seen in FIG. 7. Additionally, as seen in FIG. 8, looped structures 800 formed and are abundant in the irradiated tubes. The welding of SWNTs requires breaking of carbon bonds and rearrangement of the carbon atoms. In order for this to take place, temperatures must reach at least 1500° C., indicative of an efficient absorption of microwaves. It is well known that frequency up-conversion occurs in these regions in pyroelectric crystals. A similar mechanism may be at work in the SWNTs. Thus, the process and apparatus of the present invention described herein is an effective means of welding nanotubes or nanotube-based ropes in their pure states or after dispersion in blends or composites, thereby altering the mechanical properties of the final materials.

Summary of Inventive Aspects

When exposed to microwave fields SWNTs show intense broadband light emission, extreme heating, outgassing of previously adsorbed materials, and tube reconstruction. As noted, the expulsion of hydrogen from the carbon nanotubes is adaptable in a plurality of applications, including in reusable fuel cells. The present invention can be particularly adapted for use in fuel cell storage in vehicles, including automobiles and small disposable fuel cell sources for rocketry, and gas fuel storage for long term space missions. Advantages of this process and apparatus are cost effectiveness, safety and recyclable fuel cell material. Further, the field emissions in the UV region, with the peak intensity at approximately 328 nm, which corresponds to a known carbon emission line, may find application as a UV laser source. Some of the hydrogen may be inside of the nanotubes, thereby becoming ionized and forming a plasma, which would contribute to the UV-emission being observed. The mechanical explanation of the out-gassing of the hydrogen in the present invention is due to tube flexure as well as phonon collision resulting from high temperatures. Additional applications of the process of the present invention include portable heating sources for many uses, including military use, and as small, portable, high yield power battery sources. The present invention includes both the process described herein and any apparatus that is constructed to implement the process described herein.

The innovative teachings of the present invention are described with particular reference to its use in making fuel cells and heating sources using several fuels, such as hydrogen and oxygen, and deluent gases such as nitrogen and argon. Furthermore, a specific embodiment of undertaking the novel process is described herein. It should be understood and appreciated by those skilled in the art that the uses, and embodiment described herein provide only a few examples of the many advantageous uses and innovative teachings herein. For example, different vacuum pressures and microwave power settings and frequencies can be used to obtain approximately the same novel results, such as light emission, out-gassing, heating and tube reconstruction functions. Further, different fuels can be held, and then outgassed from the carbon nanotubes. Various alterations, modifications and substitutions can be made to the process of the disclosed invention and the apparatus' that implement the present invention without departing in any way from the spirit and scope of the invention.

1. An apparatus for generating localized heat and light, comprising an EM radiation source with a desired power setting and frequency;
a source of at least one carbon nanotube located proximate to said EM radiation source; and
a means of exposing the carbon nanotube to the EM radiation source for a predetermined duration.

2. The apparatus of claim 1 wherein the carbon nanotubes deliver controlled amounts of heat energy and light energy from low levels to very intense levels to microscopic locations in a remote object.

3. The apparatus of claim 2 wherein the EM exposed carbon nanotubes release controlled amounts of heat energy linearly with the amount of carbon nanotubes exposed tot he EM.

4. The apparatus of claim 1, wherein the carbon nanotubes are located in an oxygen-free environment.

5. The apparatus of claim 1 wherein the EM radiation is in between the radio and x-ray regions.

6. The apparatus of claim 5 wherein carbon nanotubes of different diameters are used to adjust the peak intensity of the emitted light wavelengths.

7. The apparatus of claim 5 wherein carbon nanotubes containing materials or impurities trapped within the interior thereof are used to adjust the peak intensity of the emitted light wavelengths.

8. The apparatus of claim 5 wherein the EM radiation is between 2 GHz and 90 GHz.

9. The apparatus of claim 5 wherein the EM radiation is between 2.4 GHz and 12 GHz.

10. The apparatus of claim 5 wherein the use of different frequencies of the EM radiation are operable to adjust the intensity of the emitted light wavelengths and heat emission.

11. The apparatus of claim 1 wherein the power setting of the EM source is between 30 Watts and 1000 Kilowatts.

12. The apparatus of claim 1 wherein the power setting of the EM source is between 3 Watts and 1 kilowatt.

13. The apparatus of claim 1 wherein the distance from the EM radiation source to the carbon nanotubes is between 0.0001 meters and more than 5 meters.

14. The apparatus of claim 1, adapted to remove and ionize hydrogen in one step from a storage matrix.

15. The apparatus of claim 14 for use in a fuel cell based on electromagnetic ionization of hydrogen.

16. These apparatus of claim 15 wherein ionized atoms are separated through a membrane into positive and negatively charged particles operable to generate a potential or voltage.

17. The apparatus of claim 1, wherein the carbon nanotubes are adapted to act as an emission source for charged particles, such as electrons or ions, when placed under electrical bias.

18. The apparatus of claim 1 wherein the carbon nanotubes are microscopic in size, operable to provide an intense microscopic heat source at a desired location.

19. The apparatus of claim 18, wherein the carbon nanotubes range from nanometer size to multiple grams.

20. The apparatus of claim 1 wherein the temperature at the location of the carbon nanotubes are controllable by adjusting the microwave power.

21. The apparatus of claim 1, wherein the carbon nanotubes comprise SWNTs.

22. The apparatus of claim 1, wherein the carbon nanotubes comprise purified SWNTs

23. The apparatus of claim 1, wherein the carbon nanotubes comprise raw SWNTs

24. The apparatus of claim 1, wherein the carbon nanotubes comprise MWNTs.

25. The apparatus of claim 1, adapted to provide a controlled light intensity to a remote location.

26. The apparatus of claim 1 further comprising the blending of the carbon nanotubes into a matrix.

27. The apparatus of claim 26, wherein the blended carbon nanotubes are selectively superheated with applied EM radiation;
said superheated carbon nanotubes being operable to radiate heat into the matrix in which they are blended; and
said superheating being operable to cause a rapid increase in temperature in the storage matrix.

28. The apparatus of claim 1, operable to initiate chemical reactions or physical processes at a predetermined location.

29. A process for generating localized heat and light, comprising locating a source of carbon nanotubes proximate to the location to be exposed to the heat and light;
locating an EM source with a desired power and frequency proximate to the carbon nanotubes; and
exposing the carbon nanotubes to the EM source for a predetermined duration.

30. The process of claim 29, further comprising:
delivering controlled amounts of heat energy and light energy from low levels to very intense levels to microscopic locations in a remote object.

31. The process of claim 29, further comprising exposing carbon nanotubes to EM radiation operable to release controlled amounts of heat energy linearly with the amount of carbon nanotubes so exposed.

32. The process of claim 29, further comprising locating the carbon nanotubes in a non-oxidizing environment.

33. The process of claim 29, further comprising irradiating the carbon nanotubes with EM radiation between the radio and x-ray regions.

34. The process of claim 33, further comprising using carbon nanotubes of different diameters to adjust the peak intensity of the emitted light wavelengths.

35. The process of claim 33, further comprising using carbon nanotubes containing materials or impurities trapped within the interior thereof to adjust the peak intensity of the emitted light wavelengths.

36. The process of claim 33, further comprising irradiating the carbon nanotubes with EM radiation between 2 GHz and 90 GHz.

37. The process of claim 33, further comprising irradiating the carbon nanotubes with EM radiation between 2.4 GHz and 12 GHz.

38. The process of claim 33, further comprising irradiating the carbon nanotubes with EM radiation of different frequencies to adjust the intensity of the emitted light wavelengths and heat emission.

39. The process of claim 29, further comprising irradiating the carbon nanotubes with EM radiation having power of between 30 Watts and 1000 Kilowatts.

40. The process of claim 29, further comprising irradiating the carbon nanotubes with EM radiation having power of between 3 Watts and 1 Kilowatt.

41. The process of claim 29, further comprising locating the EM radiation source from the carbon nanotubes between 0.0001 meters and 5 meters or more.

42. The process of claim 29, further comprising:
locating the carbon nanotubes within a local region of an object;
applying the EM irradiation toward the carbon nanotubes; and
releasing stored energy therein to act upon said local region of an object in which the carbon nanotubes are distributed.

43. The process of claim 29, further comprising removing and ionizing hydrogen or other materials from the carbon nanotubes from a storage matrix in one step proportional to the surface charge density of the carbon nanotubes.

44. The process of claim 29, further comprising using the storage matrix as a fuel cell based on electromagnetic ionization of hydrogen.

45. The process of claim 44, further comprising separating the ionized atoms through a membrane into positive and negatively charged particles operable to generate a potential or voltage.

46. The process of claim 45, further comprising adapting the cell to act as an emission source for charged particles, such as electrons or ions, when placed under electrical bias.

47. The process of claim 29, further comprising generating heat at a desired microscopic location by applying the EM source to a microscopic sized carbon nanotube.

48. The process of claim 47, wherein the carbon nanotubes range from nanometer size to multiple grams.

49. The process of claim 29, further comprising controlling the temperature at a desired location of the carbon nanotubes by adjusting the power of the EM source directed at such carbon nanotube.

50. The process of claim 29, wherein the carbon nanotubes comprise SWNTs.

51. The process of claim 29, wherein the carbon nanotubes comprise MWNTs.

52. The process of claim 29, wherein the carbon nanotubes comprise purified SWNTs.

53. The process of claim 29, wherein the carbon nanotubes comprise raw SWNTs.

54. The process of claim 29 further comprising blending the carbon nanotubes into a matrix.

55. The process of claim 54 wherein the blended carbon nanotubes are selectively superheated with applied EM radiation;
said superheated carbon nanotubes being operable to radiate heat into the matrix in which they are blended; and
said superheating being operable to cause a rapid increase in temperature in the storage matrix.

56. The process of claim 29, further comprising initiating chemical reactions or physical processes at a predetermined location.
